(19) United States
(12) Patent Application Publication
(10) Pub. No.: US 2002/0149208 A1
(43) Pub. Date: Oct. 17, 2002

(54) Latch mechanism

(76) Inventor: Paul Zamberg, Fountain Valley, CA (US)

Correspondence Address: Bruce B. Brunda, STETINA BRUNDA GARRED & BRUCKER, Suite 250, 75 Enterprise, Aliso Viejo, CA, 92656, US

(21) Appl. No.: 09/835,776

(22) Filed: Apr. 16, 2001

(51) Int. Cl. E05C 19/10

(52) U.S. Cl. 292/98

(57) ABSTRACT

A latch mechanism comprising a bolt assembly and a striker plate assembly. The bolt assembly itself comprises a bolt housing which is fabricated from a ferrous material. Pivotally connected to the bolt housing is an arm which is moveable between an inward position and an outward position relative to the bolt housing. Slidably attached to the bolt housing is a bolt which itself is moveable between an unlatched position and a latched position relative to the arm. Attached to the bolt is a first magnet, while attached to the bolt housing is a second magnet. The first and second magnets are oriented relative to each other such that the first magnet is magnetically repelled by the second magnet when the bolt is moved to the unlatched position so as to bias the arm to the outward position. The first magnet is magnetically attracted to the bolt housing when the arm is moved to the latched position so as to draw the arm to the inward position.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to latches, and more particularly to a latch mechanism having a bolt assembly which makes use of the forces of magnetic repulsion and attraction to enhance the operability thereof.

There is currently known in the prior art a wide variety of latch assemblies which are used to secure adjacent members to each other, such as the lid and body of an equipment case. When used for this particular application, a plurality of latch assemblies are typically spaced along the parting line between the lid and the body of the equipment case. Typical prior art latch assemblies each include a striker plate assembly and a bolt assembly which are mounted to the lid and body, respectively. The bolt assembly typically includes an arm assembly, one end of which is pivotally connected to a bracket secured to the floor of a bolt half cup. The arm assembly itself includes a bolt which slidably extends from one end thereof and is engageable to a striker plate of the striker plate assembly. The striker plate itself typically resides in a striker half cup of the striker plate assembly. The extension and retraction of the bolt from the arm assembly is typically controlled by the rotation of a key which is rotatably connected to the arm assembly. The key is rotatable to a stowed position so as to be substantially enclosed within the bolt half cup to protect it from accidental engagement with other equipment and/or personnel when the lid is secured to the body of the equipment case.

The bolt and striker half cups of the prior art latch assemblies are typically configured to jointly form a full cup or recess when the lid and body are joined to each other. The recess substantially receives and protects the latch apparatus, with the bolt and striker half cups defining holes to receive fasteners such as rivets for the attachment of the latch assemblies to the case. When the bolt is fully extended and removed from engagement to the striker plate, the lid may be removed or separated from the body of the equipment case. However, in many prior art latch assemblies, the disengagement of the bolt from the striker plate allows the arm assembly to freely rotate outward from the body along an arc. As the arm assembly freely rotates along the arc, it projects from the body which places it in position to strike other equipment with consequent damage to itself and to the other equipment. In these positions, it also forms a considerable hazard to personnel working adjacent the equipment case. Another consequence of such free rotation of the arm assembly is that it complicates assembly of the equipment case lid and body. In this respect, if the body is oriented such that gravity is causing the arm assembly to freely swing downward along the arc until it abuts the floor of the cup, the bolt will in turn be directed into the side of the striker plate which inhibits engagement of the lid and the body to each other. This occurrence requires that an assembler lift and hold the arm assembly to clear the striker plate as the lid and body are moved together to join along the parting line of the case. It will be recognized that when several latches are involved, as with large equipment cases, the time and energy required to properly position and hold several arm assemblies, often against the effect of gravity, may be considerable.

In order to address the above-described deficiencies of prior art latches, there has been developed in the prior art a latch assembly which is disclosed in U.S. Pat. No. 5,511,834 entitled Automatically Positioned Latch Assembly issued Apr. 30, 1996, A latch assembly similar to that shown in the '834 patent is identified as prior art in FIGS. 1 and 2 of the present application. As swill be discussed in more detail below, the prior art latch assembly disclosed in the '834 patent and shown in FIGS. 1 and 2 attempts to overcome the above-described deficiencies of older prior art latches through its inclusion of a leaf spring between the bolt half cup and arm assembly. This leaf spring normally urges or biases the arm assembly to a first spaced relationship relative to the bolt half cup, with the spaced relationship allowing the bolt to clear the striker plate when the bolt and striker plate assemblies are positioned for engagement to each other. The arm assembly may then be rotated against the urging or biasing force applied by the spring into engageable alignment with the striker plate. Another feature of the latch assembly shown in FIGS. 1 and 2 is that an abutment member is formed on the bracket. The abutment member is operative to prevent the arm assembly from rotating past a prescribed spaced relationship with the bolt half cup. This spaced relationship prevents rotation of the arm assembly to a position where it constitutes a hazard to adjacent equipment and/or personnel.

Though the latch assembly disclosed in the '834 patent and shown in FIGS. 1 and 2 of the present application possesses certain enhanced capabilities over earlier prior art latches, such latch assembly itself possesses certain deficiencies which detract from ins overall utility. One such deficiency lies in the relatively high level of compressive pressure that must be applied to the arm assembly to overcome the biasing force exerted by the leaf spring as is needed to rotate the arm assembly to a position whereat the bolt may be engaged to the striker plate. Another deficiency lies in the inability to rotate, under any circumstance, the arm assembly beyond the abutment member which is desirable under certain circumstances. More particularly, in older to properly service the latch assembly, grease must be added or applied on occasion to prescribed areas of the arm assembly. The failure to grease the latch assembly from time to time will often result in its failure at a rapidly accelerated rate. As will be recognized, the inability in the prior art latch assembly to rotate the arm assembly beyond the abutment member makes the greasing operation extremely difficult to complete. These particular deficiencies are overcome by the latch mechanism of the present invention which employs the use of forces of magnetic repulsion and retraction to assist in the inward and outward movement of the arm assembly. These and other advantages of the present latch mechanism will be discussed in more detail below,

### BRIEF SUMMARY OF THE INVENTION

In accordance with the present invention, there is provided a latch mechanism which comprises a bolt assembly. The bolt assembly itself comprises a bolt housing which is fabricated from a ferrous material, such as stainless steel. The bolt housing is formed to include a recessed portion which is at least partially circumvented by a flange portion. The recessed portion is itself at least partially defined by a generally planar bottom wall of the bolt housing.

Attached to the bottom wall of the bolt housing is a support bracket of the latch mechanism which is also fabricated from a ferrous material and resides within the recessed portion of the bolt housing. The support bracket is formed to include a spaced, generally parallel pair of sidewalls. The sidewalls are themselves formed to be capable of resilient flexion. Formed on respective ones of the sidewalls is a pair of projections.

The bolt assembly of the latch mechanism further comprises an arm which is pivotally connected to the support bracket and moveable between an inward position and an outward position relative to the bottom wall of the bolt housing. The pivotal connection of the arm to the support bracket is facilitated by a pair of torsion springs. Slidably attached to the arm is a bolt which is linearly moveable between an unlatched position and a latched position relative to the arm. The bolt is formed to includes a distal engagement lip. The arm resides within the recessed portion of the bolt housing such that the arm and the bolt are disposed below the flange portion when the arm is in the inward position. In the bolt assembly, the projections formed on the sidewalls of the support bracket are frictionally engageable to the arm and operative to obstruct the pivotal movement of the arm beyond an angular spacing of about forty-five degrees relative to the bottom wall when the arm is moved to the outward position. However, the application of force to the arm beyond a certain threshold will result in the outward flexion of the sidewalls of the support bracket as will permit the arm to be moved beyond the projections and pivoted to an angular spacing relative to the bottom wall of the bolt housing exceeding forty-five degrees. The arm may be rotated back to a position between the projections and the bottom wall of the bolt housing by again applying force to the arm at a level sufficient to facilitate the outward flexion of the sidewalls of the support bracket.

The bolt assembly of the latch mechanism further comprises a latch handle which is rotatably connected to the arm and mechanically coupled to the bolt. More particularly, attached to and protruding from the latch handle is a pin, a portion of which resides within a cam slot formed within the bolt. The rotation of the latch handle in a first direction facilitates the travel of the pin within the cam slot in a manner causing the bolt to be moved toward its unlatched position. Conversely, the rotation of the latch handle in a second direction opposite the first direction facilitates the movement of the pin in the cam slot as results in the movement of the bolt toward its latched position. Also formed within the bolt is a retention tab which is received into a complementary detent formed within the latch handle when the latch handle reaches the limit of its rotation in the second direction. The latch handle is also pivotally connected to the arm, and moveable to a stowed position whereat it resides within the recessed portion of the bolt housing below the flange portion.

The bolt assembly of the present latch mechanism further comprises a first magnet which is attached to the bolt, and a second magnet which is attached to the support bracket. The first and second magnets are oriented relative to each other such that the first magnet is magnetically repelled by the second magnet when the bolt is moved to the unlatched position so as to bias the arm to the outward position. Conversely, the first magnet is magnetically attracted to the support bracket when the bolt is moved to the latched position so as to draw the arm to the inward position. As will be recognized, the force of magnetic attraction facilitates the inward movement of the arm without any compressive pressure being applied thereto.

The latch mechanism further comprises a striker plate assembly which itself comprises a striker housing and a strike plate which is attached to the striker housing. The engagement lip of the bolt is engageable to the striker plate when the bolt is moved to the latched position subsequent to the movement of the arm to the inward position.

### BRIEF DESCRIPTION OF THE DRAWINGS

These, as well as other features of the present invention, will become more apparent upon reference to the drawings wherein:

FIG. 1 is a top plan view of a prior art latch mechanism;

FIG. 2 is a front perspective view of the prior art latch mechanism shown in FIG. 1;

FIG. 3 is a top plan view of the bolt assembly of the latch mechanism of the present invention;

FIG. 4 is a top perspective view of the bolt assembly of the present latch mechanism;

FIG. 5 is a front perspective view of the bolt assembly of the present latch mechanism; and

FIG. 6 is a top perspective view of the striker plate assembly of the present latch mechanism.

### DETAILED DESCRIPTION OF THE INVENTION

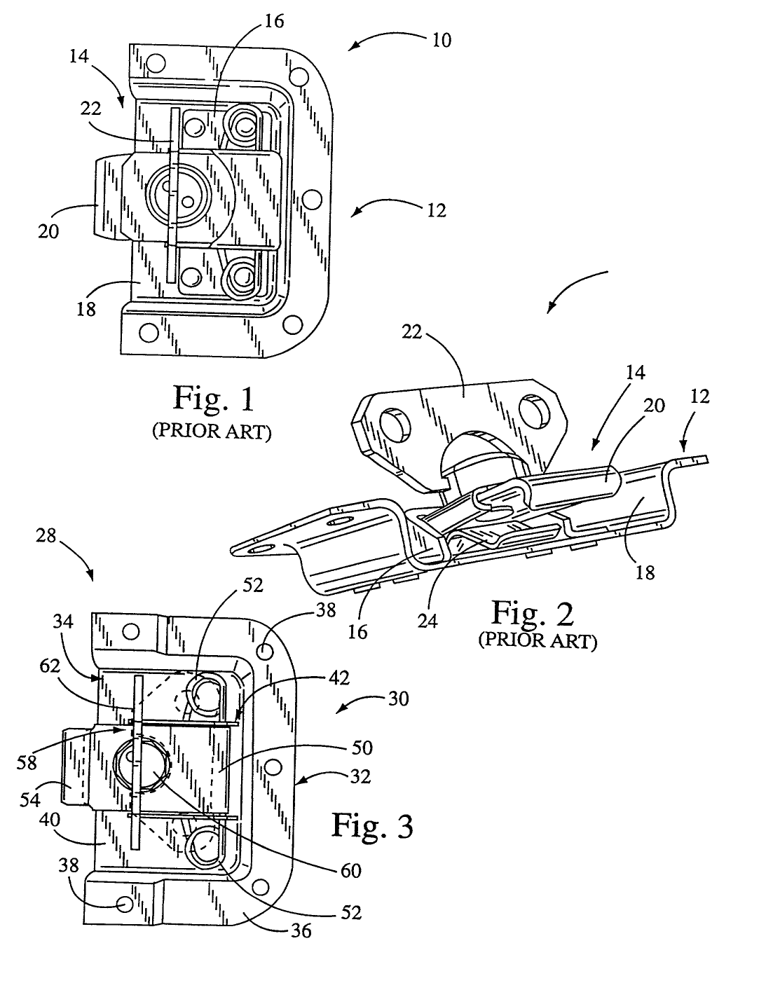

Referring now to the drawings, FIGS. 1 and 2 illustrate a prior art latch assembly 10. The prior art latch assembly 10 is typically used to secure adjacent members to each other, such as the lid and body of an equipment case. As indicated above, when used for this particular purpose, a plurality of latch assemblies 10 are typically spaced along the parting line between the lid and body of the equipment case. The latch assembly 10 includes a striker plate assembly (not shown) and a bolt assembly 12 which are mounted to the lid and body, respectively, of the equipment case. The bolt assembly 12 includes an arm assembly 14, one end of which is pivotally connected to a bracket 16 secured to the floor of a bolt half cup 18. The arm assembly 14 itself includes a bolt 20 which slidably extends from one end thereof and is engageable to a striker plate of the striker plate assembly. The striker plate itself typically resides in a striker half cup of the striker plate assembly. The extension and retraction of the bolt 20 from the arm assembly 14 is typically controlled by the rotation of a key 22 which is rotatably connected to the arm assembly 14. The key 22 is rotatable to a stowed position so as to be substantially enclosed within the bolt half cup 18 to protect it from accidental engagement with other equipment and/or personnel when the lid is secured to the body of the equipment case.

As also indicated above, the latch assembly 10 includes a leaf spring 24 which is disposed between the bolt half cup 18 and the bolt 20 of the arm assembly 14. The leaf spring 24 normally urges or biases the arm assembly 14, and hence the bolt 20, to a first spaced relationship relative to the floor of the bolt half cup 18, with the spaced relationship allowing the bolt 20 to clear the striker plate when the bolt assembly 12 and striker plate assembly are positioned for engagement to each other. The arm assembly 14 must then be rotated against the urging or biasing force applied by the leaf spring 24 into engageable alignment with the striker plate.

The latch assembly 10 further includes an abutment member 26 which is formed on the bracket 16 and is operative to prevent the arm assembly 14 from rotating past a prescribed spaced relationship with the floor of the bolt half cup 18.

As also indicated above, the deficiencies of the latch assembly 10 include the relatively high level of compressive pressure that must be applied to the arm assembly 14 to overcome the biasing force exerted by the leaf spring 24 as is needed to rotate the arm assembly 14 to a position whereat the bolt 20 may be engaged to the striker plate. Another deficiency lies in the inability to rotate, under any circumstance, the arm assembly beyond the abutment member 26. In certain circumstances, such rotation is desirable.

Referring now to FIGS. 3-6, there is depicted a latch mechanism 28 constructed in accordance with the present invention. The latch mechanism comprises a bolt assembly 30 (shown in FIGS. 3-5). The bolt assembly 30 itself comprises a bolt housing 32 which is fabricated from a ferrous material, such as stainless steel. The bolt housing 32 is formed to include a recessed portion 34 which is at least partially circumvented by a flange portion 36. Formed within the flange portion 36 are a plurality of apertures 38 which are sized and configured to accommodate fasteners such as rivets used to facilitate the attachment of the bolt assembly 30 to an article such as the lid or bolt of an equipment case. The recessed portion 34 of the bolt housing 32 is at least partially defined by a generally planar bottom wall 40 of the bolt housing 32.

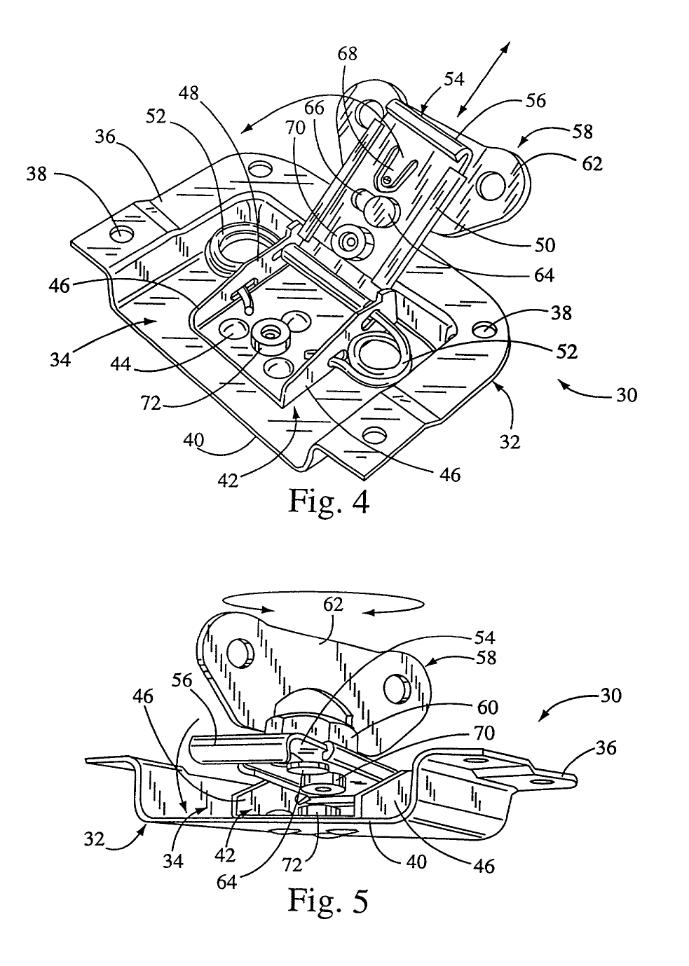

Attached to the bottom wall 40 of the bolt housing 32 is a support bracket 42 of the bolt assembly 30 which is also fabricated from a ferrous material and resides within the recessed portion 34 of the bolt housing 32. As seen in FIG. 4, the attachment of the support bracket 42 to the bottom wall 40 may be accomplished via fasteners 44 such as rivets. The support bracket 42 is formed to include a spaced, generally parallel pair of sidewalls 46. The sidewalls 46 are formed to be capable of resilient flexion for reasons which will be discussed in more detail below. Formed on respective ones of the sidewalls 46 is a pair of projections 48, the use of which will also be discussed in more detail below.

The bolt assembly 32 of the latch mechanism 28 further comprises an arm 50, the proximal end of which is pivotally connected to the support bracket 42. The arm 50 is selectively moveable between an inward position (shown in FIG. 3) and an outward position (shown in FIG. 5) relative to the bottom wall 40 of the bolt housing 32. The pivotal connection of the arm 50 to the support bracket 42 is facilitated by an opposed pair of torsion springs 52. More particularly, as best seen in FIG. 4, one end of each torsion spring 52 is received into a complementary opening disposed within a respective sidewall 46 of the support bracket 42, with the opposite end of the torsion spring 52 being advanced into a tubular, cylindrically configured portion of the arm 50 formed at the proximal end thereof.

Slidably attached to the arm 50 is a bolt 54 which is selectively extensible from and retractable into the distal end of the arm 50. In this respect, the bolt 54 is linearly moveable relative to the arm 50 between an unlatched position (shown in FIG. 3) and a latched position (shown in FIG. 4). The slidable engagement of the bolt 54 to the arm 50 is facilitated by the advancement of the bolt 54 into a pair of complementary channels defined by the arm 50 and extending along respective ones of the opposed longitudinal sides thereof. As further seen in FIG. 4, the bolt 54 is formed to include a distal engagement lip 56.

In the present latch mechanism 28, the arm 50, and hence the bolt 54, reside within the recessed portion 34 of the bolt housing 32 when the arm 50 is in its inward position. More particularly, both the arm 50 and bolt 54 are disposed below the flange portion 36 of the bolt housing 32 when the arm 50 is in its inward position. In the bolt assembly 30, the projections 48 formed on the sidewalls 46 of the support bracket 42 are frictionally engageable to respective ones of the longitudinal sides of the arm 50, and operative to obstruct the pivotal movement of the arm 50 beyond an angular spacing of about forty-five degrees relative to the bottom wall 40 when the arm 50 is moved to its outward position. However, as seen in FIG. 4, the application of force to the arm 50 beyond a certain threshold will result in the outward flexion of the sidewalls 46 of the support bracket 42 as will permit the arm 50 to be moved beyond the projections 48 and pivoted to an angular spacing relative to the bottom wall 40 of the bolt housing 32 exceeding forty-five degrees. The arm 50 may be rotated back to a position between the projections 48 and the bottom wall 40 by again applying force to the arm 50 at a level sufficient to facilitate the outward flexion of the sidewalls 46 of the support bracket 42. Thus, in contrast to the latch assembly 10 shown in FIGS. 1 and 2, the arm 50 of the latch mechanism 28 of the present invention may, when desired, be pivoted or rotated beyond an angular spacing of about forty-five degrees relative to the bottom wall 40 of the bolt housing 32 to allow for the servicing of the latch mechanism 28.

The bolt assembly 30 of the latch mechanism 28 further comprises a latch handle 58 which is rotatably connected to the arm 50 and mechanically coupled to the bolt 54. The latch handle 58 includes a cylindrical portion 60 which is rotatably connected to the arm 50, and a key portion 62 which is pivotally connected to the cylindrical portion 60. Attached to and protruding from one end of the cylindrical portion 60 is a pin 64, a portion of which resides within a cam slot 66 formed within the bolt 54. As seen in FIG. 4, the pin 64 is formed to include an enlarged head which maintains the same in engagement to the bolt 54. The rotation of the key portion 62 and hence the cylindrical portion 60 of the latch handle 58 in a first direction facilitates the travel of the pin 64 within the cam slot 66 in a manner causing the bolt 54 to be moved toward its unlatched position. Conversely, the rotation of the latch handle 58 in a second direction opposite the first direction facilitates the movement of the pin 64 in the cam slot 66 as results in the movement of the bolt 54 toward its latched position. Also formed within the bolt 54 is a retention tab 68. The distal end of the retention tab 68 is received into a complementary detent formed within the cylindrical portion 60 of the latch handle 58 when the latch handle 58 reaches the limit of its rotation in the second direction. As indicated above, the key portion 62 of the latch handle 58 is pivotally connected to the cylindrical portion 60 thereof. Such pivotal connection allows for the actuation of the key potion 62 from an operative position (shown in FIGS. 3 and 5) to a stowed position (shown in FIG. 4). When in the stowed position, the key portion 62 resides within the recessed portion 34 of the bolt housing 32 below the flange portion 36. The key portion 62 may be pivoted to either side to facilitate its movement into the stowed position.

As best seen in FIGS. 4 and 5, the bolt assembly 30 of the latch mechanism 28 further comprises a circularly configured first magnet 70 which is attached to the inner surface of the bolt 54 between the proximal end of the bolt 54 and the cam slot 66 formed therein. Attached to the support bracket 42 is a circularly configured second magnet 72. The first and second magnets 70, 72 are oriented relative to each other such that the first magnet 70 is magnetically repelled by the second magnet 72 when the bolt 54 is moved to its unlatched position. This force of magnetic repulsion has the effect of biasing the arm 50 to its outward position. Conversely, when the bolt 54 is moved to its latched position, the first magnet 70 is magnetically attracted to the ferrous support bracket 42. This force of magnetic attraction has the effect of drawing the arm 50 to its inward position. Advantageously, the force of magnetic repulsion in the present latch mechanism 28 biases the arm 50 to a prescribed angular orientation relative to the bottom wall 40 of the bolt housing 32. However, due to the use of the first and second magnets 70, 72, the need to apply compressive pressure to the arm 50 to urge the same to its inward position is eliminated since the movement of the bolt 50 to its latched position results in the elimination of the force of magnetic repulsion in favor of the force of magnetic attraction which assists in drawing the arm 50 to its inward position.

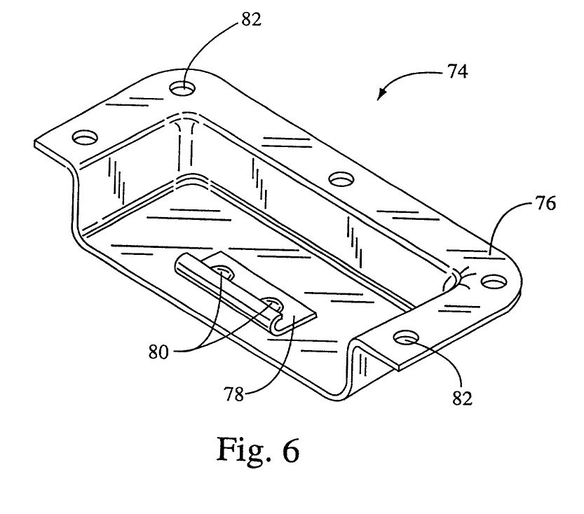

Referring now to FIG. 6, the latch mechanism 28 of the present invention further comprises a striker plate assembly 74. The striker plate assembly 74 itself comprises a striker housing 76 and a striker plate 78 which is attached to the striker housing 76 via fasteners 80 such as rivets. The lip 56 of the bolt 54 is engageable to the striker plate 78 of the striker plate assembly 74 when the bolt 54 is moved to its latched position subsequent to the movement of the arm 50 to its inward position. Also formed within the striker housing 76 are a plurality of apertures 82 which are used to facilitate the attachment of the striker plate assembly 74 to an article such as a lid or body of an equipment case through the use of fasteners such as rivets.

Additional modifications and improvements of the present invention may also be apparent to those of ordinary skill in the art. Thus, the particular combination of parts described and illustrated herein is intended to represent only one embodiment of the present invention, and is not intended to serve as limitations of alternative devices within the spirit and scope of the invention.

1. A latch mechanism comprising:
a bolt assembly comprising:
a bolt housing fabricated from a ferrous material;
an arm pivotally connected to the bolt housing and movable between an inward position and an outward position relative thereto;
a bolt slidably attached to the arm and movable between an unlatched position and a latched position relative thereto;
a first magnet attached to the bolt; and
a second magnet attached to the bolt housing;
the first and second magnets being oriented relative to each other such that the first magnet is magnetically repelled by the second magnet when the bolt is moved to the unlatched position so as to bias the arm to the outward position, and the first magnet is magnetically attracted to the housing when the bolt is moved to the latched position so as to draw the arm to the inward position.

2. The latch mechanism of claim 1 further comprising:
a striker plate assembly comprising:
a striker housing; and
a striker plate attached to the housing;
the bolt being engageable to the striker plate when moved to the latched position subsequent to the movement of the arm to the inward position.

3. The latch mechanism of claim 2 wherein the bolt includes a distal lip portion sized and configured to engage the striker plate when the bolt is moved to the latched position subsequent to the movement of the arm to the inward position.

4. The latch mechanism of claim 1 wherein:
the bolt housing defines a recessed portion and a flange portion which at least partially circumvents the recessed portion; and
the arm resides within the recessed portion such that the arm and the bolt are disposed below the flange portion when the arm is in the inward position.

5. The latch mechanism of claim 4 further comprising:
a support bracket fabricated from a ferrous material and attached to the housing so as to be disposed within the recessed portion thereof;
the arm being pivotally connected to the support bracket with the second magnet being attached to the support bracket.

6. The latch mechanism of claim 5 wherein the arm is pivotally connected to the support bracket via a pair of torsion springs.

7. The latch mechanism of claim 5 wherein:
the recessed portion of the housing is at least partially defined by a bottom wall thereof; and
the support bracket is attached to the bottom wall and includes at least one projection which is frictionally engageable to the arm and operative to obstruct the pivotal movement of the arm beyond an angular spacing of about forty-five degrees relative to the bottom wall when the arm is moved to the outward position.

8. The latch mechanism of claim 7 wherein:
the support bracket defines a spaced, generally parallel pair of sidewalls;
a pair of projections are formed on respective ones of the sidewalls; and
the sidewalls are formed to be capable of resilient flexion so as to allow for the pivotal movement of the arm beyond the projections to an angular spacing of greater than about forty-five degrees relative to the bottom wall of the housing.

9. The latch mechanism of claim 7 wherein the bolt assembly further comprises a latch handle rotatably connected to the arm and mechanically coupled to the bolt in a manner wherein the rotation of the latch handle in a first direction facilitates the movement of the bolt toward the unlatched position, and the rotation of the latch handle in a second direction opposite the first direction facilitates the movement of the bolt toward the latched position.

10. The latch mechanism of claim 9 wherein the handle is pivotally connected to the arm and moveable to a stowed position whereat the latch handle resides within the recess of the bolt housing below the flange portion thereof.

11. The latch mechanism of claim 9 wherein:
the arm includes a cam slot formed therein; and
the latch handle includes a pin attached thereto and protruding therefrom, a portion of the pin residing within the cam slot;
the rotation of the latch handle facilitating the movement of the pin within the cam slot in a Tanner resulting in the movement of the bolt relative to the arm.

12. The latch mechanism of claim 9 wherein:
the arm includes a retention tab formed therein; and
the latch handle includes a detent formed therein;
a portion of the retention tab being received into the detent when the latch handle reaches a rotational limit in the second direction.

13. A latch mechanism comprising:
a bolt assembly comprising:
a bolt housing;
an arm pivotally connected to she bolt housing and movable between an inward position and an outward position relative thereto;
a bolt slidably attached to the arm and movable between an unlatched position and a latched position relative thereto; and
a biasing mechanism attached to the bolt and to the bolt housing;
the biasing mechanism being configured in a manner wherein the arm is urged by the biasing mechanism to the outward position when the bolt is moved to the unlatched position, and the arm is drawn by the biasing mechanism to the inward position when the bolt is moved to the latched position.
